(19) United States
(12) Patent Application Publication
(10) Pub. No.: US 2005/0231893 A1
(43) Pub. Date: Oct. 20, 2005

(54) Electric double layer capacitor enclosed in polymer housing

(76) Inventor: Troy A. Harvey, Salt Lake City, UT (US)

Correspondence Address: Troy A. Harvey, 7875 Da Vinci Dr., Salt Lake City, UT, 84121, US

(21) Appl. No.: 11/109,155

(22) Filed: Apr. 19, 2005

Related U.S. Application Data
(60) Provisional application No. 60/563,310, filed on Apr. 19, 2004.

(51) Int. Cl. H01G 9/00

(52) U.S. Cl. 361/502

(57) ABSTRACT

The present invention relates to an electric double layer capacitor comprised of carbonaceous electrodes enclosed in polymer housing, using conductive polymer current collectors intrinsically bonded to both the electrodes and the enclosure, and a method for constructing the same. The present invention also relates to bipolar stacks of electric double layer capacitor cells and a method for producing the same.

### CROSS-REFERENCES TO RELATED APPLICATIONS

This application is a continuation-in-part of and claims priority to U.S. Provisional Patent Application No. 60/563,310 entitled “Electric double layer capacitor enclosed in polymer housing” and filed on Apr. 19, 2004 for Troy Aaron Harvey

### BACKGROUND OF THE INVENTION

1. Field of the Invention

The present invention relates to an electric double layer capacitor comprised of carbonaceous electrodes enclosed in polymer housing, using conductive polymer current collectors, and a method for constructing the same. The present invention also relates to bipolar stacks of electric double layer capacitor cells and a method for producing the same.

2. Discussion of Prior Art

Electric double-layer capacitors have substantially increased the specific capacitance achievable over traditional capacitor technologies. This has enabled capacitors to achieve energy densities that have made capacitors applicable to many pulse-power and backup-power applications such as uninterruptible power supplies, utility power, electric and hybrid automobiles, photovoltaic storage, and the like.

Despite their potential, electric double layer capacitors have often suffered from, amongst other things, low multi-cell packaging densities, metallic impurities, difficultly in constructing bipolar stacks, and packaging costs. The reason for these problems is discussed below.

Most double-layer capacitors have utilized metal foil current collectors, usually aluminum, as a means to move the current from the active electrodes to outside of the cell. While metal foils generally have high conductivity and work well for this purpose, metal foils also have several limitations. One such limitation is difficultly in bonding the metal collectors to the carbon electrodes without excessive process steps. Another limitation is the difficultly in making bipolar stack arrangements with metal collectors separating the cells while achieving acceptable sealing against the non-conductive and therefore non-metallic case. Another issue is the side reactions that can occur between the metal foils and metallic impurities inherent in the carbonaceous electrodes, once the electrodes are polarized.

A polymer-carbon conductive composite current collector may solve some of the problems referred to above, such as sealability, where having a polymer collector facilitates bonding to a non-conductive polymer housing such that a full seal can be achieved. However, polymer collectors typically have been fabricated using powdered active electrode constituents and rubber materials for the collectors. This arrangement requires the use of external metal clamping mechanisms to hold the electrode under sufficient pressure in order to provide particle-to-particle contact and conductivity.

Still, others have used the same conductive polymer-carbon compounds to construct current collectors, but have used adhesives to bond them to the electrode. And still others have used intrinsically conductive polymers, such as polypyroles, polyanilines, and polythiophenes, but these are commercially cost-prohibitive.

### SUMMARY OF THE INVENTION

The present invention has been developed in response to the present state of the art, and in particular, in response to the problems and needs in the art that have not yet been fully solved by currently available packaging for electric double-layer capacitors. Accordingly, the present invention has been developed to provide packaged electric double layer capacitors that overcome many or all of the above-discussed shortcomings in the art.

The apparatus, in one embodiment, is configured to enable bipolar designs that have sufficiently high packaged volumetric energy density to be practically useful for bulk energy storage. The apparatus may comprise a set of polarizable electrodes comprising a carbonaceous material and a conductive polymer housing to enclose the polarizable electrodes. The conductive polymer housing may be thermally bonded to each polarizable electrode to form a plurality of conductive end plates. The double layer capacitors may be economical to construct and may be made without metallic materials in the cell.

### BRIEF DESCRIPTION OF THE DRAWINGS

FIG. 1 is a cross-sectional view illustrating an arrangement of a high energy-density double-layer capacitor according to one embodiment of the current invention;

FIG. 2 is a cross-sectional view illustrating a process of heat-press laminating electrodes to a conductive polymer current collector according to one embodiment of the current invention;

FIGS. 3A-3B are cross-sectional views illustrating a process of mirror welding electrodes to a polymer-carbon current collector according to one embodiment of the current invention;

FIGS. 4A-4C are perspective views illustrating a process of making a series connected bipolar stack of electric double layer capacitors according to the embodiment of the current invention arranged into a single capacitor high-voltage module;

FIGS. 5A-5C are cross-sectional views illustrating an injection molding process of making a series connected bipolar stack of electric double layer capacitors according to the embodiment of the current invention arranged into a single capacitor high-voltage module;

FIG. 6 is a cross-sectional view illustrating a process according to the embodiment of the current invention of hot roll welding of electrode sheets to a conductive polymer current collector;

FIG. 7 is a perspective view illustrating a wound cylinder type packaging of the high electric double-layer capacitor according to the embodiment of the current invention;

FIG. 8 is a cross-sectional view illustrating a process according to the embodiment of the current invention of hot roll welding of a single electrode sheet to a conductive polymer current collector;

FIG. 9 is a cross-sectional view illustrating a process according to one embodiment of the current invention of hot roll welding electrode sheets to an ion-permeable membrane and further hot roll welding two conductive polymer current collectors to the two electrode sheets, respectively.

### DESCRIPTION OF THE PREFERRED EMBODIMENTS

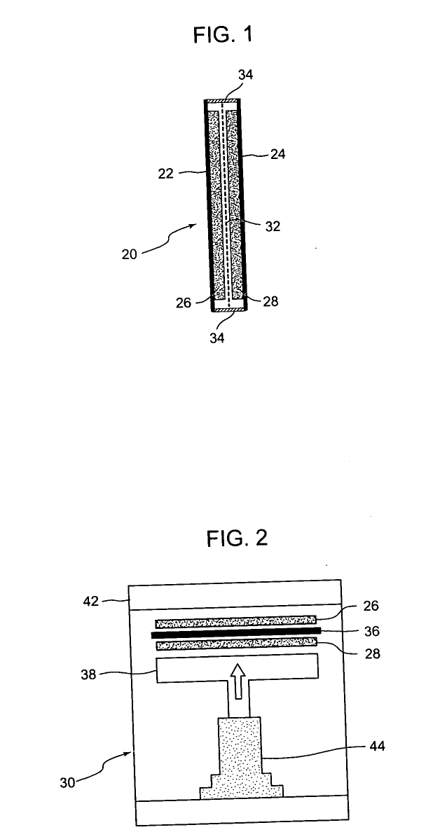

Explanation will be made below with reference to FIGS. 1-9 for illustrative embodiments concerning an electric double-layer capacitor, its enclosure, and a method for producing the same according to the present invention.

An electric double-layer capacitor, according to one embodiment of the present invention, includes for example, a type of unit cell 20 as depicted in the cross-sectional view in FIG. 1. The unit cell 20 may include a positive polarizable electrode 26 and a negative polarizable electrode 28. The electrodes 26, 28 may be fabricated in such a fashion as to make them self-structured durable forms, as will be discussed below. The unit cell 20 may also contain two conductive polymer current collectors 22, 24, which may also serve as barrier endplates where the gap between the two current collectors 22, 24 is spanned by a polymer wall 34 around the perimeter forming a sealed envelope. The current collectors 22, 24 may serve the dual function of both sealing the ends of the capacitor cell and providing conduction out of it. In addition, the polarizable electrodes 26, 28 may be bonded to the two collectors 22, 24 using heat to flow the polymer of the current collectors 22, 24 into the surface of said electrodes in order to mechanically and electrically interlock the two according to one embodiment of the current invention, thus enabling conduction of electricity out of the cell. The unit cell 20 may further include an optional separator 32 interposed between the polarizable electrodes 26 and 28 to provide electrical isolation between said electrodes while allowing electrolyte conductivity. The separator 32 may be fused to one or both electrode surfaces.

The conductive polymer current collectors 22, 24 may be a mixture of polymer(s) and substantially conductive substance(s). The polymer of current collector 22, 24 may be, but is not limited to: polyethylene, polypropylene, ethylene-propylene rubber, ethylene octene, polyvinylidene chloride, polyvinylidene fluoride, polytetrafluoroethylene, polyetheretherketone; including blends, mixtures, copolymers, thermoplastic vulcanizates, tacticity variants, and functionality substitution variants of any or combinations of the above polymers. Alternatively, the polymer may be a thermoset resin such as furfural, phenolic or epoxides.

In certain embodiments, the polymer of current collector 22, 24 may be a compound, copolymer, mixture or blend of two or more polymers with different melt flow rates or melting temperatures. More specifically, the polymer may be a compounded mixture of polypropylene and polyethylene where the ratio is between 99.5:0.5 and 15:85 respectively. The polymer may be a blend, mixture or copolymer between polypropylene or polyethylene and ethylene-propylene rubber or ethylene-propylene diene rubber, which may be further vulcanized with a vulcanization agent such as maleic anhydride. The weld temperature may be chosen so that the polyethylene flows, having a lower melt temperature, while the polypropylene matrix does not substantially flow, thus reducing overall shrinkage and reducing stress on the electrode.

The conductive substance of current collectors 22, 24 may be substantially a carbonaceous material which may be comprised of a carbon black, graphite, carbon powder, carbon fiber, carbon nanotubes, carbon fibulae, activated carbon or some combination there of. Alternatively, the conductive substance may also be a metal powder, fiber or combination. Furthermore, the metal may be largely comprised of, but not limited to: aluminum, magnesium, manganese, or beryllium or alloys thereof. The conductive substance may contain both carbonaceous material(s) and metallic material(s) in order to impart conductivity into the polymer. In a preferred embodiment, the ratio of the polymer to the conductive substance is 85:15 to 50:50, and more preferably 80:20 to 55:45, and most preferably 70:30 to 60:40.

The polymer and conducive substance of 22, 24 may be compounded together in a manner to achieve a fine dispersion of the conductive substance in the polymer matrix, such as is achievable with a high shear twin screw mixer.

In the depicted embodiment, the unit cell 20 may be immersed or filled with an organic electrolyte and then sealed to contain the electrolyte. After which the cell 20 may be further laminated, coated, or enclosed with metal foils, polymer foil laminates, metal or ceramic depositions, or a metal envelope in order to impede water vapor mobility into the cell 20.

FIG. 2 illustrates one embodiment of a method of bonding the electrodes 26 and/or 28 to the conductive polymer current collector 36 in accordance with the present invention. A current collector 36 may be interposed with either one or two electrodes and placed in a press 30, having heated platens 38, 42. Upon engaging the actuator 44, such that pressure is applied to the electrode(s) 26, 28 and collector 36, the heat from the platens 38, 42 partially flows the collector 36 material into the porous structure of the electrodes, and once cooled, forms a tight mechanical and electrical interlock.

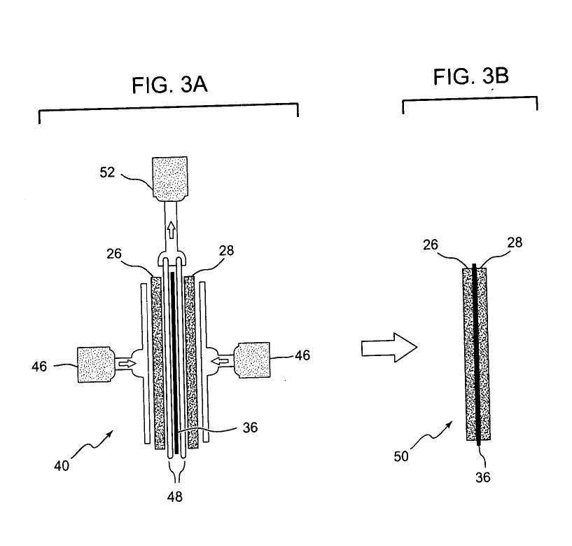

Another method of forming an electrode-collector-electrode trilaminate according to the present invention is depicted in FIG. 3A. As illustrated, the apparatus 40 does a type of mirror welding where heated plates 48 heat both the faces of the polymer current collector 38 and the faces of the self-bound electrodes 26, 38. The heat may flow the polymer of the current collector 38 such that where actuator 52 retracts the heated plates 48 and actuator(s) 46 extends in order to press electrodes 26, 28 into the softened polymer faces of the current collector 38. Once cooled sufficiently to eject the formed laminate 50 as shown in FIG. 3B from the aforementioned apparatus, the electrodes 26, 28 may be solidly bound to the current collector 36.

Such trilaminated electrode 26, current collector 36, and electrode 28 assemblies may also be formed by heat pressing, rotational molding, low pressure molding, pressure molding, hot-roll welding, ultrasonic welding, orbital welding, vibrational welding, laser/infrared/photonic welding, spin welding, or electric resistance welding according to one embodiment of the present invention.

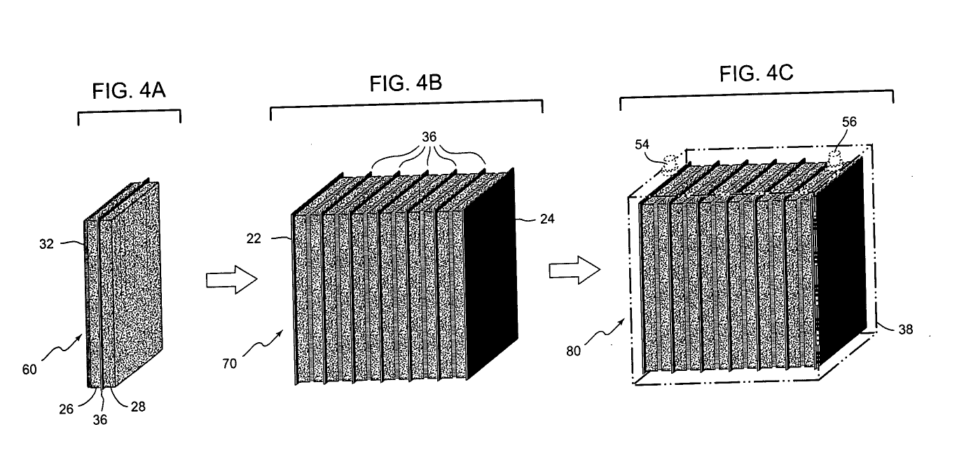

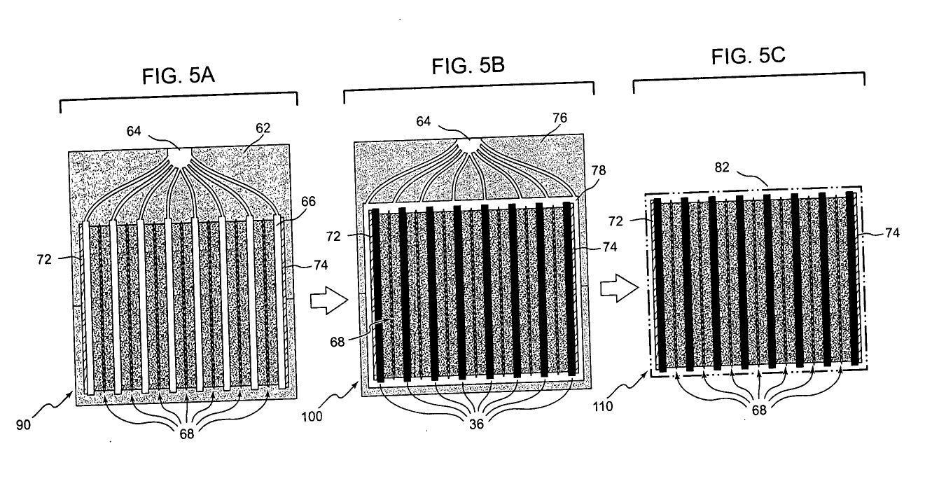

Multiple trilaminates 50 after being stacked into unit cells may subsequently be connected in series or parallel electrical arrangements (or combinations thereof) in a single package in order to provide higher voltage stacks, as illustrated by the embodiments depicted in FIGS. 4A to 4C and FIGS. 5A to 5C.

In one such embodiment, a type of capacitor module 80, shown in FIG. 4D, is constructed using a multiplicity of trilaminates 60 depicted in FIG. 4A. Each of the trilaminates 60 may include a positive polarizable electrode 26 and a negative polarizable electrode 28 that may be physically and conductively bonded to a current collector 36, according to one embodiment of the current invention. The trilaminate 60 may further include an optional separator 32, such that multiple trilaminates are stacked in order to form a series bipolar arrangement of cells 70 that becomes interleaved between the polarizable electrodes 26 and 28, thus enabling electrical isolation between said electrodes while allowing electrolyte conductivity. Once stacked, the trilaminates 60 form separate cells divided by bipolar current collectors 36, such that each positively polarized electrode shares an electrical collector 36 with the negatively polarized electrode of the adjacent cell in order to conduct electricity through the full face of the collector, each cell in turn until the end cells terminate in the end collectors 22, 24.

The bipolar stack 70 may be enclosed in a polymer housing 80 and filled with an electrolyte, such that the polymer current collectors 22, 24, 36 bond around the periphery of the cell to the housing 80 in order to isolate the cells and the electrolyte therein. The terminals 54, 56 provide means to move electric current from within the stack to outside the housing. Methods by which the housing may be bound to the collector may include, but are not limited to: heat pressing, mirror welding, rotational molding, low pressure molding, injection molding, hot-roll welding, ultrasonic welding, orbital welding, vibrational welding, laser/infrared/photonic welding, or spin welding according to one embodiment of the present invention.

In another embodiment, a type of bipolar capacitor module 110, illustrated in FIG. 5C, may be constructed using a multiplicity of unit cells 68 in FIG. 5A. Each of the unit cells 68 may include a positive polarizable electrode and a negative polarizable electrode and an optional separator, as previously described. In the depicted embodiment, the unit cells are placed in an injection mold frame 62 of an injection molding machine 90, such that the injection mold frame holds the unit cells in place. The unit cells may have open chambers 66 with the dimensions desired for the polymer current collectors. The polymer, containing conductive additive(s) according to one embodiment of the present invention, may thereafter be injected into the open chambers 66 by way of plastic injection channels 64 in order to fill the individual void spaces between unit cells 68 and optional terminal plates 72, 74. The conductive polymer, in one embodiment, partially flows into the porous surface in order to sufficiently bond the electrodes of the unit cells 68. The terminal plates 72, 74, in a preferred embodiment, being comprised of a metal or metal alloy, most preferably aluminum, provide means to electrically connect the bipolar stack of cells, sealed in the polymer housing, to external connections, the terminal end plates being sealed from the cell.

To facilitate the bonding of the polymer end plate to the metal current collectors 72, 74, an intermediary layer of modified polymer may be used. The modifier may contain functionalities to increase the surface energy of the polymer so it bonds well to a metal substrate. Such modifiers may be polar chlorine, oxide, amino, carboxyl or hydroxyl groups.

Alternatively, to facilitate the bonding of the polymer end plate to the metal current collectors 72, 74, an intermediary layer of modified polymer may be used, having been corona or plasma treated in order to improve adhesion on the metal surface. The polymer, in a preferred embodiment, is polypropylene, and more preferably polypropylene containing 0.1 to 1 weight percent ethylene.

Alternatively, to facilitate the bonding of the polymer end plate to the metal current collectors 72, 74, the metal current collector, typically aluminum, may be treated with a surface finish to reduce its surface energy, thereby facilitating bonding with the low surface energy polymer endplates. Such surface finishes may include chromate conversion coating, or silane coupling agents, such as octadecyltrichlorosilane or perfluorodecyltrichlorosilane.

The conductive polymer may be low pressure injection molded or injection molded using a low melt flow polymer. The rate flow rate, in a preferred embodiment, is below 4, more preferable the melt flow rate is below 1, and most preferably below 0.5 g/10 min as per ASTM D 1238.

After the current collector conductive polymer material is injected into the open chambers, the stack may be either moved into a second mold frame 100, illustrated in FIG. 5B, or left within the same mold frame 100 having movable parts in order to change the shape of the spaces 78 of the mold cavity to prepare the mold cavity for injection molding of the non-conductive enclosure around the now formed current collectors 36. Injecting the nonconductive polymer enclosure around the individual cells and current collectors seals the individual cells from one another and the metal terminal end plates, while leaving a small opening in the top of each cell. The terminals protruding from the case (not shown) carry the current from the stack of cells to an external connection.

After removing the stack from the injection mold cavity, the cells may be filled with an electrolyte through remaining openings in each cell, which after filling are sealed shut. The enclosed stack may then optionally be coated with a metal, ceramic, or plastic coating, which inhibits the moisture permeability of the enclosure. Alternatively, the enclosed stack may be wrapped in a metal foil or metal foil-polymer and then be heat sealed or placed back into the mold frame 100 to have another thickness of polymer overmolded around the metal film. In an alternative embodiment, the metal foil may be placed in the initial enclosure molding, as depicted in FIG. 5B and discussed above, and positioned such that the polymer flows on both sides of the foil in order to both seal the housing and provide a vapor barrier. In another embodiment, the case may be placed in a metal container, with electric terminal feedthroughs, and hermetically welded closed.

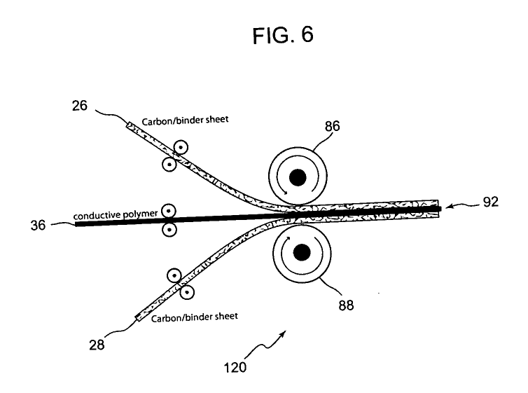

Alternatively, sheets of tri-laminated electrode material may be constructed in a continuous or semi-continuous roll process 120 as shown in FIG. 6. The sheets of polarizable electrode material 26, 28 with a conductive polymer current collector, according to one embodiment of the present invention, is fed through counter rotating hot rollers, such that the laminate 92 is fed through the roller while heating the conductive polymer current collector 36 in order to cause it to sufficiently flow into the electrode material, creating a mechanical and electrical bond. The laminates may then be cut and stacked into a bipolar arrangement and moved into a mold frame 100, illustrated in FIG. 5B, to prepare it for injection molding of the non-conductive enclosure around the laminate current collectors 36. Injecting the nonconductive polymer enclosure around the individual cells and current collectors seals the individual cells from one another and the metal terminal end plates, while leaving a small opening in the top of each cell.

Alternatively, the trilaminate may be formed in method similar to the method described above in FIG. 6, wherein the rollers provide pressure, but heat is supplied separately to the face of the conductive polymer current collector. The heat source may be positioned to melt a surface layer of the polymer current collector before the electrode is placed in contact with said current collector. After which pressure may be applied to embed the electrode into the molten surface of the current collector. The heat source may be a hot roller, flame, hot air, radiating heater, or an intrinsically hot current collector from a previous process such polymer extrusion of the current collector sheets.

Alternatively, sheets of tri-laminated electrode and current collector may be constructed by a method of co-extrusion. The electrodes may be passed through an extrusion die with a gap between them, wherein molten polymer is forced by pressure between the electrodes, such that a continuous extruded laminate is formed through the face of the die.

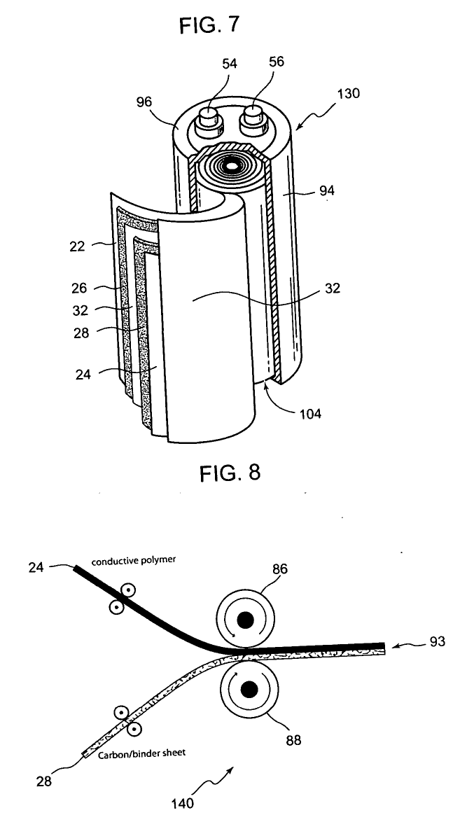

In addition to the flat type cells and bipolar embodiments of the electric-double layer capacitors described above, a wound type embodiment 130 may also be available as shown in FIG. 7. Such a system may use sheets of laminated electrode material, as may be constructed in a continuous roll process 140 as shown in FIG. 8. Sheets of polarizable electrode material 28 may be laminated to a conductive polymer current collector 24, according to one embodiment of the present invention. In this embodiment, the sheets are fed through counter rotating hot rollers 86, 88 such that in the completed laminate 93 the conductive polymer current collector 36 is heated in order to cause it to sufficiently flow into the electrode material, creating a mechanical and electrical bond.

Two such laminates 93 may be wound together in the manner shown in FIG. 7 with electrically isolating ion-permeable membranes 32 interposed on both sides in order to form a wound core 48. The wound core may be comprised of a positive polarizable electrode 26 and current collector 22 laminate, and a negative polarizable electrode 28 and current collector 24 laminate in order to have a cylindrical configuration.

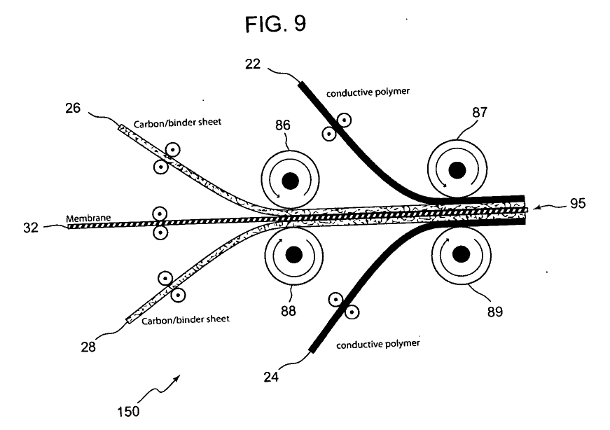

Alternatively, a wound capacitor, such as the wound capacitor 130 in FIG. 7, may also be constructed using a 5-layer or 6-layer laminate, a 5-layer example of which is illustrated in FIG. 9. Such a system may use sheets of laminated electrode material, as may be constructed in a continuous roll process 150. The sheets of polarizable electrode material 26, 28 may be laminated to either side of an ion-permeable membrane by means of counter rotating hot rollers 86, 88. Then sheets of conductive polymer current collectors 22, 24 may be further laminated on either side of the electrode sheets 26, 28 using heat rollers 87,89 such that in the completed laminate 95, the conductive polymer current collectors 22, 24 are heated in order to cause them to sufficiently flow into the electrode material, creating a mechanical and electrical bond. In a six-layer variant, a second ion-permeable membrane may be laminated to either current collector 22 or 24.

In an alternative embodiment shown in FIG. 9, a 5-layer laminate is wound together in the manner shown in FIG. 7, with a second electrically isolating ion-permeable membrane 32 layered on one side of the laminate in order to form a wound core 104. The wound core may include a positive polarizable electrode 26 and current collector 22 laminate, and a negative polarizable electrode 28 and current collector 24 laminate, in order to have a cylindrical configuration.

The wound core 104 may be accommodated, for example, in a cylindrical aluminum or polymer-foil case 94, which may be filled with an organic electrolyte (not shown). The case may be sealed with a top plate 96 through which terminals 54, 56 carry the electricity from the aforementioned collectors 22, 24.

Carbon materials suitable for use in the electric double layer capacitor electrodes 26, 28 may include carbon, activated carbon, carbon black, graphitic carbon, alkali activated graphitic or non-graphitic carbon (processed at high temperatures with alkalis such as KCO₃, KOH, K, Na, NaOH, NaCO₃, etc), carbon fibers, carbon nanotubes, carbon fibrils, or a combination thereof. The carbons or mixtures thereof may also contain a fluorine-containing polymer, as a binding agent, such as polytetrafluoroethylene (PTFE), an ethylene-tetrafluoroethylene copolymer (ETFE), a chlorotrifluoroethyl-ethylene polymer (PCTFE), a vinylidene fluoride copolymer (PVDF), a tetrafluoroethylene-hexafluoropropylene copolymer (FEP), or a tetrafluoroethylene-perfluoroalkylvinyl ether copolymer (PFA). Alternatively, the binder may also be comprised of a polyolefin polymer or co-polymer, such as polypropylene, polyethylene, ethylene-octene, or ultra high molecular weight polyethylene.

In one embodiment, the carbons may be bound together with carbon-bearing substance, emulsion or adhesive—then formed into blocks or sheets and processed into a conductive electrode at high temperature. The high temperature process pyrolyzation leaves behind only a conductive carbonaceous remnant of the binder. Such carbon bearing substances may include methyl cellulose, polyvinylidene difluoride, coal tar, petroleum tar, asphaltenes, fly ash, cellulose, starches, and proteins; preferred carbon-bearing substances being thermosetting resins, such as phenolic, resorcinol, or furfural resins. Alternatively, the carbon may be produced as a monoblock, formed from carbon bearing precursors such as methyl cellulose, polyvinylidene difluoride, coal tar, petroleum tar, cokes, asphaltenes, fly ash, cellulose, starches, proteins, phenolic resins, furfural resins, and epoxide resins and then carbonized to form a solid electrode.

The electrostatic capacity of the electrode, expressed in farads, is developed between the solute ions of the organic electrolyte and the carbon of the electrode, whether the ions forming the electrostatic storage field are adjacent the carbon surface, diffuse, absorption on the carbon surface, or through insertion between carbon layers.

In this embodiment, the solute of the organic electrolyte may include, but is not limited to, one of the following anions: tetrafluoroborate (BF₄—), of hexafluorophosphate (PF₆—), hexafluoroarsenate (AF6—), perchlorate (ClO₄—), CF₃SO₃—, (CF₃SO₂)₂N—, C₄F₉SO₃—. The solute of the organic electrolyte may include, but is not limited to, the following cations:

One cation may be represented by the following formula:

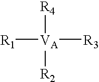

Wherein the central atom V_{A} is one of the periodic table group VA elements (N, P, As . . . ) and wherein the four radicals R₁, R₂, R₃, R₄ may individually support one of the following groups: methyl, ethyl, propyl, butyl, or pentyl. Examples include tetraethylammonium (Et₄N+) and 1-methyl-3-ethylphosponium (Et₃MeP+). Alternatively, any two of the radical attachment points may support a cyclic hydrocarbon, examples including dialkylpyrrolidinium or dialkylpiperidinium.

Another cation may be represented by the following formula.

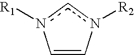

Wherein R₁ and R₂ are alkyl groups each having a number of carbon atoms or atoms of 1 to 5, R₁ and R₂ may be the same group or different groups, an example of which is 1-ethyl-3-methylimidazolium.

The solvent of the organic electrolyte may be a dipolar aprotic solvent, which may include propylene carbonate (PC), butylenes carbonate (BC), ethylene carbonate (EC), gamma-butyrolactone (GBL), gamma-valerolactone (GVL), glutaronitrile (GLN), adipnitrile (ADN), acetonitrile (AN), sulfolane (SL), trimethyl phosphate (TMP), dimethyl carbonate (DMC), ethyl methyl carbonate (EMC), or diethyl carbonate (DEC).

A solvent may include a mixture composed of a primary solvent containing at least one aprotic solvent, such as those mentioned above, and a secondary solvent containing either another of said dipolar aprotic solvents, or another non-polar organic co-solvent.

With the use of ionic liquids, such as the aforementioned imidazolium cation containing ionic liquids, the electrolyte may contain only a neat ionic liquid, and no other solvent. Alternatively, the ionic liquid co-solves another solute of cations and anions.

The present invention provides a novel method of producing an electric double layer capacitor with all polymer housing. The present invention further improves the state of the art by providing a simple and cost effective method of constructing a double layer capacitor, and a bipolar double layer capacitor in particular. The present invention also provides a housing not having any metallic elements in the active cell chamber, reducing the potential for side reactions and self discharge species.

It is a matter of course that the electric double layer capacitor, the method for producing the same, and the method for creating storage moderated energy generation systems according to the present invention are not limited to the embodiments described above, which may be embodied in other various forms without deviating from the gist of essential characteristics of the present invention.

1. A capacitor cell comprising:
a plurality of polarizable electrodes comprising a carbonaceous material; and
a conductive polymer endplate thermally bonded to at least one polarizable electrode.

2. The capacitor cell of claim 1, further comprising a non-conductive polymer housing configured to retain an electrolyte in electrolytic communication with the plurality of polarizable electrodes.

3. The capacitor cell of claim 2, wherein the non-conductive polymer housing comprises one or more polyolefin polymers or co-polymers.

4. The capacitor cell of claim 3, wherein the polyolefin polymers or co-polymers are selected from the group consisting of polyethylene, polypropylene, ethylene-octene, ethylene-propylene rubber, ethylene-propylene vulcanizates, and ultra high molecular weight polyethylene.

5. The capacitor cell of claim 2, wherein the non-conductive polymer housing comprises one or more polymers or co-polymers selected from the group consisting of polyvinylidene chloride (PVC), polyetheretherketone (PEEK), butyl rubber, styrene-buytdyne rubber, polymethyl methacrylate, polytetrafluoroethylene (PTFE), an ethylene-tetrafluoroethylene copolymer (ETFE), a chlorotrifluoroethyl-ethylene polymer (PCTFE), a vinylidene fluoride copolymer (PVDF), a tetrafluoroethylene-hexafluoropropylene copolymer (FEP), a tetrafluoroethylene-perfluoroalkylvinyl ether copolymer (PFA), furfural, phenolic, and epoxides

6. The capacitor cell of claim 1, wherein the conductive polymer endplate comprises two or more polymers of different melt temperatures.

7. The capacitor cell of claim 6, wherein the conductive polymer endplate is a blend, mixture, or copolymer between polypropylene and polyethylene, and wherein the mass ratio of the two is between 97:3 and 15:85, and wherein only the polyethylene substantially melts.

8. The capacitor cell of claim 1, wherein the conductive polymer endplate comprises two or more polymers of different melt flow rates.

9. The capacitor cell of claim 8, wherein the conductive polymer endplate is a blend, mixture or copolymer between polypropylene, or polyethylene and ethylene-propylene rubber, or ethylene-propylene diene rubber, which may be further vulcanized or cross-linked to provide better chemical resistance and strength.

10. The capacitor cell of claim 8, wherein a polymer is a polyolefin polymer or co-polymer comprising functional group-containing monomers selected from the group consisting of carboxylic acids, dicarboxylic acids, and their derivatives.

11. The capacitor cell of claim 8, wherein the polymer is a polyolefin polymer or co-polymer comprising halogenated functionalities or halogen-containing polyolefinic monomers or polymers, whereby improving the polymer adhesion to the electrode.

12. The capacitor cell of claim 1, wherein the conductive polymer endplate comprises a conductive substance blended with a polymer.

13. The capacitor cell of claim 12, wherein the conductive substance comprises a carbonaceous material.

14. The capacitor cell of claim 13, wherein the carbonaceous material is selected from the group consisting of carbon black, graphite, carbon powder, carbon fiber, carbon nanotubes, carbon fibulae, and activated carbon.

15. The capacitor cell of claim 12, wherein the carbonaceous material comprises between 20% to 45% weight of the conductive end plate composition.

16. The capacitor cell of claim 1, wherein the end plates are thermally bonded to the electrodes by a process selected from the group consisting of injection molding, rotational molding, low pressure molding, pressure molding, mirror welding, roll welding, hot-roll welding, co-extrusion, ultrasonic welding, orbital welding, vibrational welding, laser/infrared/photonic welding, spin welding, and electric resistance welding.

17. A capacitive device comprising:
a plurality of electrode pairs, each electrode comprising a polarizable carbonaceous material, the electrode pairs arranged in a stacked arrangement; and
a conductive polymer endplate thermally bonded to two polarizable electrodes from adjacent electrode pairs.

18. The capacitive device of claim 17, further comprising a non-conductive polymer housing configured to retain an electrolyte in electrolytic communication with the plurality of electrode pairs.

19. The capacitive device of claim 17, wherein the conductive polymer endplate is formed by injection molding.

20. A method for producing the capacitive device of claim 17, the method comprising:
placing the plurality of electrode pairs within an injection mold frame, the injection mold frame configured to substantially maintain a selected spacing between adjacent electrode pairs;
injecting a conductive polymer within the spacing between adjacent electrode pairs; and cooling the conductive polymer to provide electrically and mechanically interconnected electrode pairs.
